(19) United States
(12) Patent Application Publication
(10) Pub. No.: US 2025/0113291 A1
(43) Pub. Date: Apr. 3, 2025

(54) SYSTEMS AND METHODS FOR NETWORK SLICE-BASED VPLMN SELECTION/RESELECTION

(71) Applicant: INTERDIGITAL PATENT HOLDINGS, INC., Wilmingto, DE (US)

(72) Inventors: Ulises Olvera-Hernandez, Saint-Lazare, CA (US); Michael Starsinic, Newtown, PA (US); Anuj Sethi, Ottawa (CA); Saad Ahmad, Montreal (CA); Samir Ferdi, Kirkland, CA (US)

(73) Assignee: INTERDIGITAL PATENT HOLDINGS, INC., Wilmington, DE (US)

(21) Appl. No.: 18/832,055

(22) PCT Filed: Jan. 27, 2023
(86) PCT No.: PCT/US2023/011730

§ 371 Date: Jul. 22, 2024

Related U.S. Application Data
(60) Provisional application No. 63/303,800, filed on Jan. 27, 2022.
(60) Provisional application No. 63/324,889, filed on Mar. 29, 2022.

(51) Int. Cl. H04W 48/18; H04W 8/12; H04W 60/00; H04W 84/04

(52) U.S. Cl. CPC H04W 48/18; H04W 8/12; H04W 60/00; H04W 84/042

(57) ABSTRACT

In an embodiment, a wireless transmit receive unit (WTRU) includes a processor configured to receive configuration information that includes information related to S-NSSAI support for each visited public land mobile network (VPLMN) of a plurality of VPLMNs, to receive a message indicating that an S-NSSAI is not available on a current VPLMN, and to send a request message including an indication that the S-NSSAI is not available in the current VPLMN, the request message being one of a deregistration message and a registration request message based on the configuration information.

### CROSS-REFERENCE TO RELATED APPLICATIONS

This application claims the benefit of U.S. Provisional Application No. 63/303,800, filed Jan. 27, 2022; and U.S. Provisional Application No. 63/324,889, filed Mar. 29, 2022; the contents of which are incorporated herein by reference.

### SUMMARY

In systems, methods, and/or devices, there may be approaches for network slice-based VPLMN selection reselection. For example, a Steering of Roaming SoR procedure may be used to convey single Network Slice Selection Assistance Information (S-NSSAI) associated to Visited Public Land Mobile Network (VPLMN)/access technologies while a wireless transmit receive unit (WTRU) is roaming. In an example, RAT/Frequency Selection Priority (RFSP) may be used to determine S-NSSAI that may be broadcast in System Information to aid a WTRU in identifying S-NSSAIs available in neighboring cells. In an example, a WTRU may execute a Deregistration procedure upon receipt of a Registration Accept with Rejected S-NSSAIs the WTRU needs to access, and provide a new Deregistration Type to flag this occurrence. In an example, S-NSSAI-VPLMN/access technology associations in the SOR-AF may be generated using information from the VPLMN Access and Mobility Management function (AMF) and Network Slice Selection Function (NSSF).

Furthermore, in an embodiment, a wireless transmit receive unit (WTRU) includes a processor, which is configured to receive network slice selection assistance information (NSSAI) related to a visited-public-landmobile-network (VPLMN), to determine, in response to the received NSSAI, that at least one network slice is unavailable in the VPLMN, and to inform a home public land mobile network (HPLMN) that the at least one network slice is unavailable in the VPLMN.

In addition, in an embodiment, a method implemented by a wireless transmit receive unit (WTRU) includes receiving configuration information that includes information related to S-NSSAI support for each visited public land mobile network (VPLMN) of a plurality of VPLMNs, receiving a message indicating that an S-NSSAI is not available on a current VPLMN, and sending a request message including an indication that the S-NSSAI is not available in the current VPLMN, the request message being one of a deregistration message and a registration request message based on the configuration information.

Moreover, in an embodiment, a wireless transmit receive unit (WTRU) includes a processor configured to receive configuration information that includes information related to S-NSSAI support for each visited public land mobile network (VPLMN) of a plurality of VPLMNs, to receive a message indicating that an S-NSSAI is not available on a current VPLMN, and to send a request message including an indication that the S-NSSAI is not available in the current VPLMN, the request message being one of a deregistration message and a registration request message based on the configuration information.

Furthermore, in an embodiment, a method performed by a wireless transmit receive unit (WTRU) includes receiving a network slice selection assistance information (NSSAI) related to a visited-public-landmobile-network (VPLMN), determining, in response to the received NSSAI, that at least one network slice is unavailable in the VPLMN, and informing a home public land mobile network (HPLMN) that the at least one network slice is unavailable in the VPLMN.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment; and

FIGS. 2A-2B are a diagram illustrating an example process for providing S-NSSAI information to roaming WTRUs through SoR operation according to an embodiment.

FIG. 3 is a diagram of a procedure related to a WTRU declaring its capability to receive a Slice-Aware SoR Container, according to an embodiment.

FIG. 4 is a flow diagram of a procedure related to determining whether a VPLMN supports a particular network slice, according to an embodiment.

FIG. 5 is a flow diagram of a procedure related to determining whether VPLMN supports a particular S-NSSAI, according to an embodiment.

### DETAILED DESCRIPTION

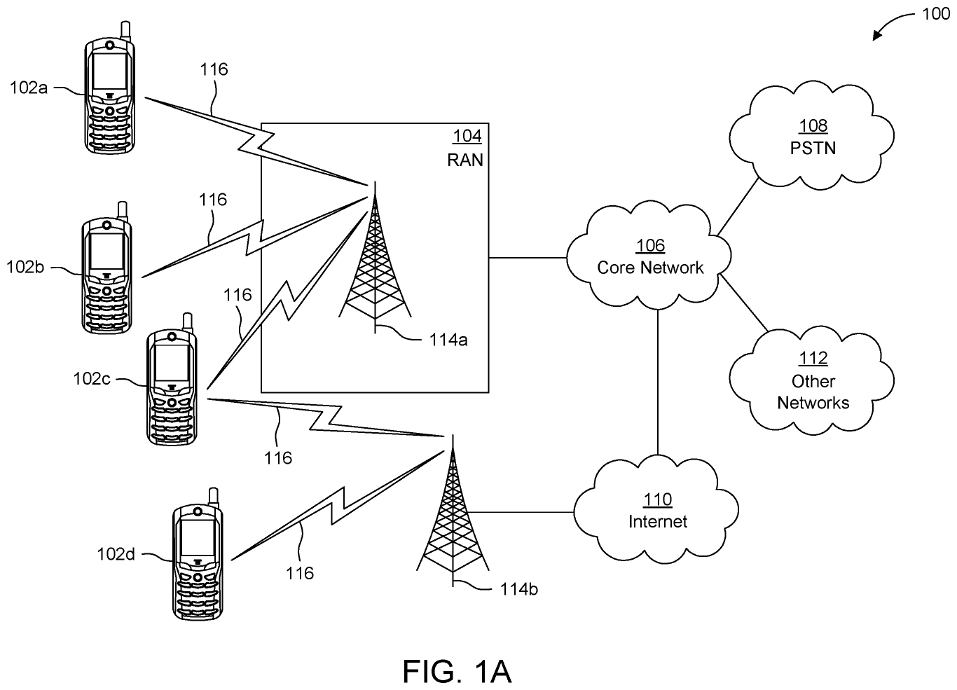

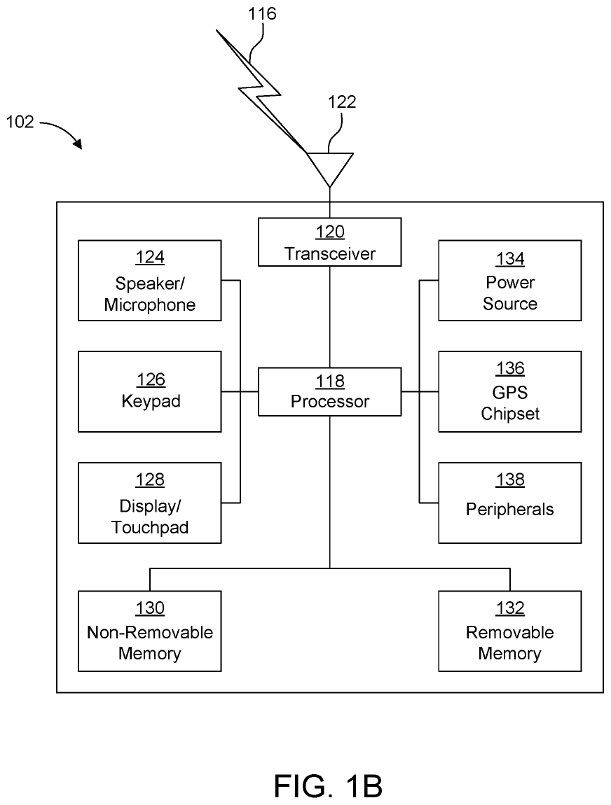

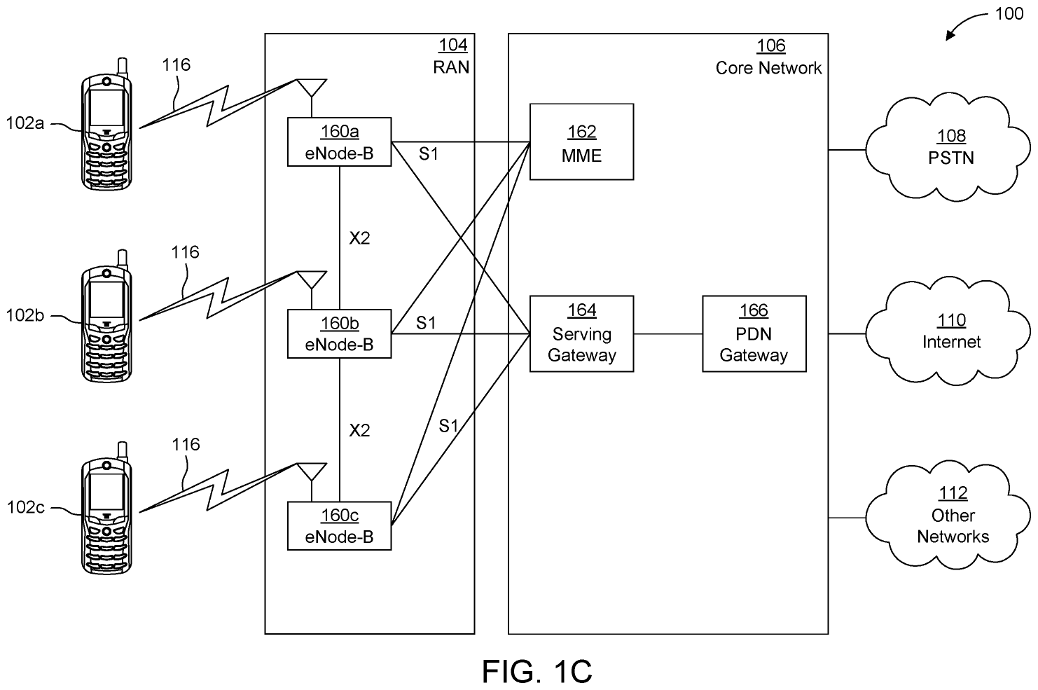

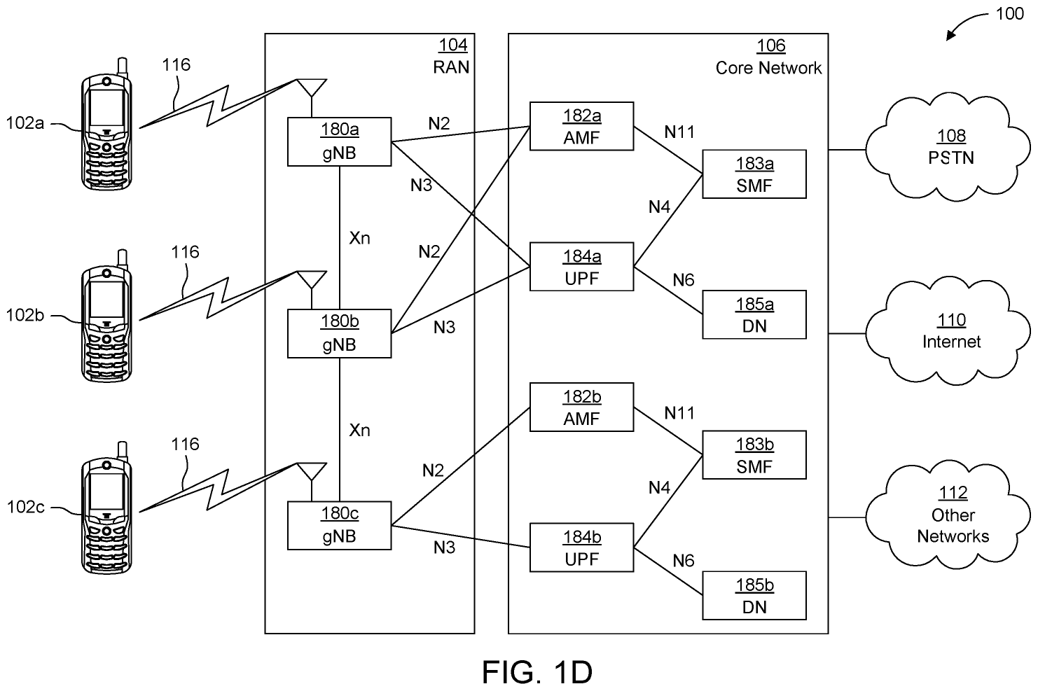

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional landline communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some cases, a WTRU may operate in a wireless communication system that employs network slicing. Network slicing may address use cases where a given use case has specific demands different from other use cases that are operating in the same wireless system.

During PLMN selection, network slicing availability may be determined. Cell reselection may be performed, using priorities, considering Single-Network Slice Selection Assistance Information (S-NSSAI)-based RAT/Frequency Selection Priority (RFSP) at a Home Public Land Mobile Network (HPLMN). For radio resource management functions, in order to support radio resource management in RAN, the AMF may provide/generate one or more parameters, such as an index to RFSP (e.g., RFSP Index). This may be provided to RAN across N2. The RFSP index may be WTRU specific and apply to all radio bearers. For example, the one or more parameters may be used to derive WTRU specific cell reselection priorities to control idle mode camping. For example the one or more parameters may be used to decide whether to redirect active mode WTRUs to different frequency layers and/or RATs.

The HPLMN may set the RFSP index taking into account one or more subscribed S-NSSAIs. The AMF may receive the subscribed RFSP index from the user data management (UDM) (e.g., during the registration procedure). For non-roaming subscribers, the AMF may choose the RFSP index in use according to a procedure, depending on an operator's configuration, such as: the RFSP index in use is identical to the subscribed RFSP index; and/or, the AMF may choose the RFSP index in use based on the subscribed RFSP index, the locally configured operator's policies, the allowed NSSAI, and the WTRU related context information available at the AMF (e.g., included the WTRU settings), if received during a registration procedure.

In one example, of the AMF may use the “WTRU's usage setting,” to select an RFSP value that enforces idle mode camping on E-UTRA for a WTRU acting in a “Voice centric” way, in the case voice over NR is not supported in the specific Registration Area and it contains NR cells.

The AMF may report to the Policy Control Function (PCF) the subscribed RFSP Index received from the UDM for further evaluation. When receiving the authorized RFSP Index from the PCF, the AMF may replace the subscribed RFSP Index with the authorized RFSP Index.

For roaming subscribers, the AMF may choose the RFSP Index in use based on the visited network policy, but may take input from the HPLMN into account (e.g., an RFSP Index value pre-configured per HPLMN, or a single RFSP Index value to be used for all roamers independent of the HPLMN).

The AMF may store the subscribed RFSP index value received and the RFSP index value in use. During the registration procedure, the AMF may update the RFSP index value in use (e.g., the AMF may need to update the RFSP index value in use if the WTRU related context information in the AMF has changed). When the RFSP index value in use is changed, the AMF may immediately provide the updated RFSP index value in use to a NG-RAN node(s) by modifying an existing WTRU context or by establishing a new WTRU context in RAN or by being configured to include the updated RFSP index value in use in the NGAP DOWNLINK NAS TRANSPORT message if the user plane establishment is not needed. During inter-AMF mobility procedures, the source AMF may forward both RFSP index values to the target AMF. The target AMF may replace the received RFSP index value in use with a new RFSP index value in use that is based on the operator's policies and the WTRU related context information available at the target AMF.

In order to enable WTRU idle mode mobility control and priority-based reselection mechanism considering availability of Network Slices at the network and the Network Slices allowed for a WTRU, an RFSP may be derived, considering also the allowed NSSAI for the WTRU.

Generally, when the HPLMN is not available (e.g., the WTRU goes out of coverage of it), the WTRU may select a VPLMN, through one or modes of operation: automatic mode, where the WTRU selects the VPLMN through a priority order list, listing a PLMN/access technology combination; and/or manual mode, where the WTRU shows the user available PLMNs and once the user chooses available PLMNs the WTRU attempts obtaining service on the PLMN.

Generally, one example purpose of the control plane approach for a steering of roaming in 5GS procedure in a PLMN is to allow the HPLMN to update a parameter in a WTRU, such as the “Operator Controlled PLMN Selector with Access Technology” list, by providing the HPLMN protected list of preferred PLMN/access technology combinations or a secured packet via NAS signaling. If the selected PLMN is a VPLMN, the HPLMN may provide the steering of roaming information to the WTRU using the control plane mechanism during and after registration. The HPLMN may update the “Operator Controlled PLMN Selector with Access Technology” based on the operator policies, which may be based on the registered VPLMN, the location of the WTRU, or the like.

It may be beneficial to improve upon the information available to a WTRU in roaming scenarios regarding the availability of network slices in VPLMNs available in the roaming country, in order to allow the WTRU to select and obtain services from the VPLMN supporting the network slices that the WTRU may wish to use.

For a roaming WTRU activating a service/application requiring a network slice not offered by the serving network but available in the area from other network(s), the HPLMN may be able to provide the WTRU with prioritization information of the VPLMNs with which the WTRU may register for the network slice.

In some cases, there may be mechanisms to prioritize cell selection/reselection based on applicable S-NSSAI, however, these cases may only apply to the HPLMN, and when applied to the VPLMN, it may be ultimately up to the visited network policies to determine how these priorities are configured. For example, for roaming subscribers the AMF may choose the RFSP index in use based on the visited network policy, but may take input from the HPLMN into account (e.g., an RFSP Index value pre-configured per HPLMN, or a single RFSP Index value to be used for all roamers independent of the HPLMN conditions. Therefore, in some cases, the HPLMN may not guarantee that S-NSSAI will be selected according to RFSP in the visited network.

Furthermore, in some cases the PLMN selection procedure may rely on a prioritized list of PLMN and access technology combinations, which is stored in the UICC. Prior to the initial registration to a VPLMN, the WTRU may not have prior knowledge of what S-NSSAIs are available in each VPLMN, and therefore is not able to select the VPLMN based on supported S-NSSAI. The WTRU may only learn that the S-NSSAI is not supported in a Tracking Area (TA) after the WTRU goes through the Registration procedure.

Additionally, in some cases the RAN may not broadcast available S-NSSAIs in the System Information, therefore the WTRU may not be aware of the supported S-NSSAIs in a cell/TA prior to attempting access on that cell/TA.

With regards to Core Network support prior to/or at Registration, although there may be procedures to steer the WTRU to VPLMNs (e.g., through SoR) that may be preferred by the home Network Operator, these mechanisms may not take into consideration subscriber preferences for Network Slices, and how these preferences influence the selection of a particular VPLMN/Access Technology combination when steering of roaming is triggered.

Accordingly, in order to address the issues that may arise in some cases, as described above (e.g., where a system may only steer a WTRU in a visited Network towards TA(s) that support S-NSSAIs that the WTRU wants to access), there may be solutions and/or approaches that address one or more of the following: how the WTRU informs the Network that it wants to move to an alternate TA where a particular S-NSSAI may be offered; how the WTRU determines that S-NSSAIs available in the serving Network (e.g., a sub-set of those included in the Request NSSAI, are not sufficient and therefore reselection is preferred; how the home network knows that there are TAs of VPLMNs available in the area where the WTRU(s) is (are) located; how the home network informs the WTRU which TA areas are available and in which VPLMN they are located; and/or, how the Network knows that the WTRU is able to process this information.

In some cases, a WTRU may request information regarding available S-NSSAI while roaming; additionally/alternatively, there may one or more methods for triggered steering of roaming with S-NSSAI support for a WTRU. The WTRU may be configured with information regarding support for S-NSSAIs, based on geographical location (e.g., per TA and/or per Access Network), and available VPLMN(s). The WTRU may maintain a list of VPLMNs/TA and Access Network combination, where Rejected S-NSSAIs have been received in the Registration Accept message, in specific TA(s) within those VPLMNs. The information configured in the WTRU regarding availability of S-NSSAI in PLMNs/Access Network and TA combinations, may be stored in the WTRU as part of the Steering of Roaming information. This information may be preconfigured in the WTRU (e.g., in the USIM or ME (Mobile Equipment) or it may be provided by the HPLMN during a Registration procedure or WTRU Configuration Update Procedure.

If the WTRU is not configured with information regarding available S-NSSAI(s) in a particular location, VPLMN/Access Technology, or it does not have preconfigured information regarding availability of S-NSSAIs in a particular area, for specific VPLMNs or VPLMNs/Access Network combinations, while the WTRU is roaming, and if the NSSP in the URSP rules indicates that an essential application is supported through an S-NSSAI (e.g., an S-NSSAI supporting services for a particular application requested by the WTRU) that has been rejected, as signaled in the Rejected S-NSSAI provided in the Registration Accept message, or that has not been included in the Allowed NSSAI, the WTRU may determine to execute a Deregistration procedure. The WTRU may indicate in the Deregistration Request message, within the Deregistration Type, that the Deregistration procedure has been triggered due to lack of S-NSSAI support (e.g., for specific S-NSSAIs). The AMF in the VPLMN may be required to inform the UDM that the WTRU has Deregistered due to lack of S-NSSAI in this VPLMN, by forwarding the Deregistration message to the UDM, using Nudm UECM Deregistration service operation.

If the UDM gets a Deregistration from the AMF and the Deregistration type indicates lack of S-NSSAIs, or an explicit request to provide Slice Aware Steering of Roaming, the UDM includes the Slice-Aware Steering of Roaming (SoR) container as part of the Output of the Nudm_UECM_Deregistration service operation. The AMF may relay the Slice-Aware SoR container to the WTRU, in the Deregistration accept message.

The WTRU may subsequently maintain a list of visiting PLMNs where a deregistration was carried out because of unavailability/no support of S-NSSAI. This list may be used for subsequent visitor PLMN selection, de-prioritizing VPLMNs where deregistration procedure was carried out because of lack of support for S-NSSAI.

In some cases, the network may trigger steering of roaming with S-NSSAI support. If during the Deregistration procedure the UDM received an indication that the WTRU has requested Deregistration due to lack of S-NSSAI support in a VPLMN, and the UDM has no indication that the WTRU is ready to receive Slice-Aware SoR information, the UDM may implicitly consider the WTRU as being capable and ready to receive Slice-Aware SoR information and, the UDM may keep a flag in the WTRU subscription information indicating that the WTRU may re-register in a different VPLMN to seek S-NSSAI support, where the flag may be called “Slice-Aware SoR required”.

During a Registration procedure, if the VPLMN AMF does not have subscription data for the WTRU, the VPLMN AMF may invoke Nudm_SDM_Get service operation to HPLMN UDM to get Access and Mobility subscription Data for the WTRU. Upon receipt of a Nudm_SDM_Get message, if the “Slice-Aware SoR required” flag is set, and as part of the Steering of Roaming procedure, the UDM may include in the list of preferred VPLMN/Access Technology combinations, a list of supported S-NSSAIs.

The VPLMN AMF may send the Steering of Roaming information, including the new S-NSSAI information associated to the VPLMN/Access Technology combination.

The WTRU may determine, based on the list of VPLMN available in the area and/or the S-NSSAIs supported in these VPLMNs, that the WTRU may attempt to obtain service on a higher priority VPLMN as specified in the received Steering of Roaming information.

In some cases, S-NSSAI availability in a Cell/TAs may be broadcasted. Subject to Operator policies in a VPLMN, if the VPLMN AMF received the subscribed RFSP Index from the UDM, it may report it to the PCF for further evaluation. If the PCF provides an authorized RFSP index, the VPLMN AMF may replace the subscribed RFSP Index with the authorized RFSP Index.

The AMF may provide one or more parameters, such as a ‘Index to RAT/Frequency Selection Priority’ (RFSP Index) to RAN across N2 to be used by the RAN. The RAN may use the RFSP Index, for example, to derive WTRU specific cell reselection priorities to control idle mode camping or to broadcast S-NSSAI information of neighboring Tas.

In some cases, S-NSSAI availability in a VPLMN may be derived through analytics. The list of preferred PLMN/access technology combinations may be dynamically generated by the SOR-AF. The SOR-AF may be enhanced to generated S-NSSAI availability analytics, such as subscribing to exposed information from AMF and NSSF in known VPLMNs. The AMFs in these VPLMNs may learn the S-NSSAIs supported per TA by the 5G-AN when the 5G-AN nodes establish or update the N2 connection with the AMF. One or all AMFs per AMF Set may provide and update the NSSF with the S-NSSAIs support per TA. The 5G-AN may learn the S-NSSAIs per PLMN ID the AMFs it connects to support when the 5G-AN nodes establish the N2 connection with the AMF or when the AMF updates the N2 connection with the 5G-AN.

In some cases, S-NSSAI availability may be determined through NSSF. When the UDM receives a new registration request from a roaming WTRU, the UDM may obtain a list of available S-NSSAIs per PLMN and TA, from the NSSF, using existing NSSF service operations, such as Nnssf_NSSAIAvailability_Subscribe service operation. Alternatively, if the UDM uses the SOR-AF, the SOR-AF may use the NSSF service to obtain the list of S-NSSAIs that are available per PLMN and TA.

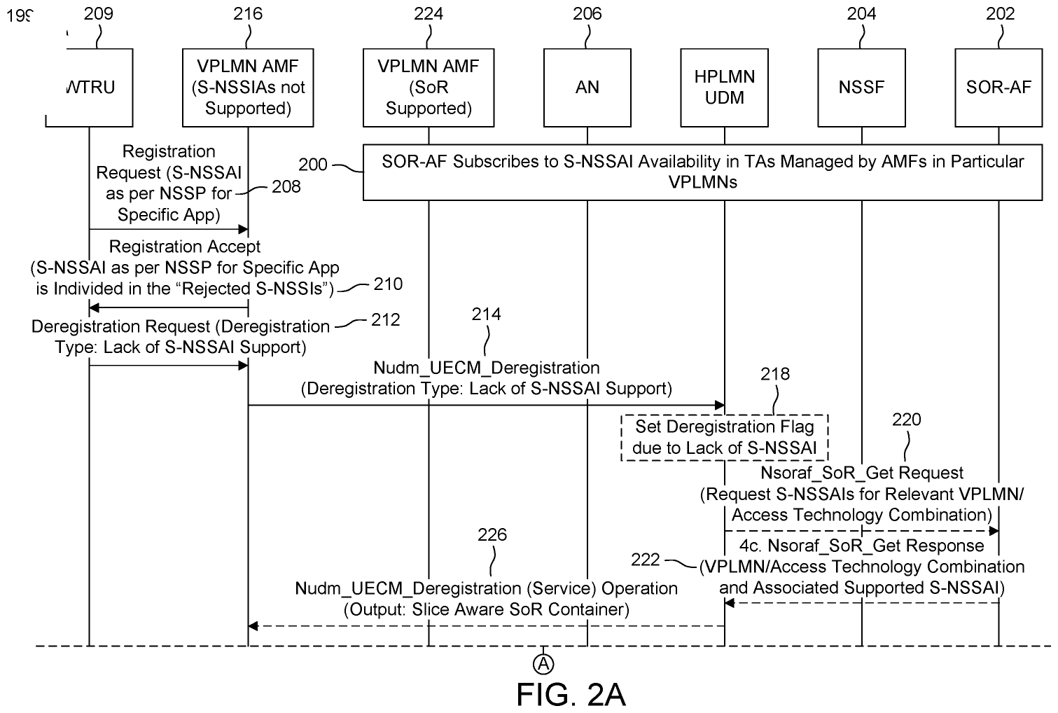

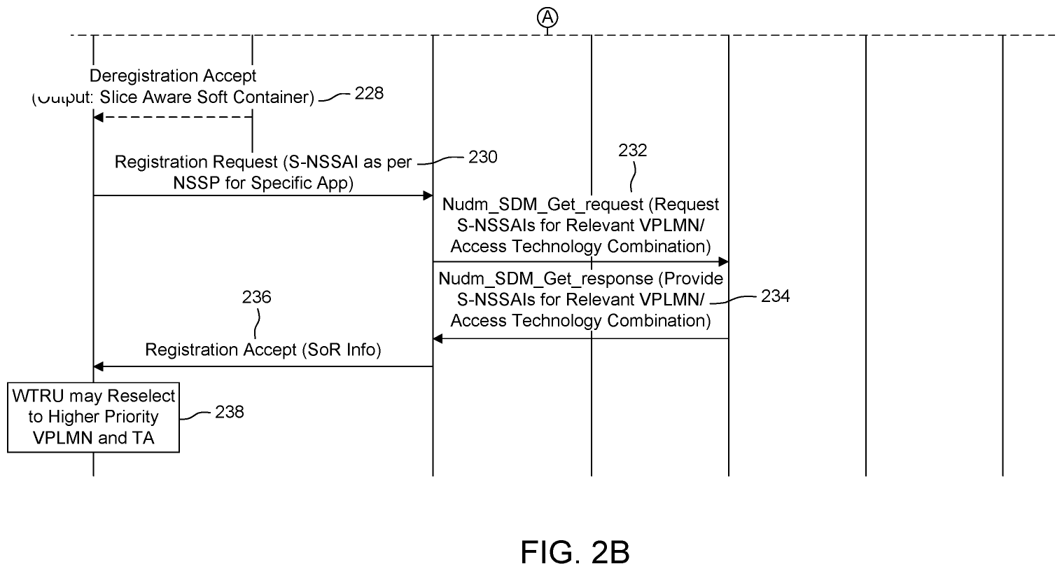

FIGS. 2A-2B are a diagram of an example procedure 199 for providing S-NSSAI information to roaming WTRUs through a SoR operation, according to an embodiment.

As shown, at 201 the SOR-AF 202 may generate information on available S-NSSAIs in one or more VPLMN/access technology combinations by using information provided by AMFs in specific regions. The AMF may gather this information with the help of an NSSF 204 and an AN 206, when the 5G-AN nodes establish or update the N2 connection with the AMF.

At 208, a WTRU 209 may request access Registration to a VPLMN in its current VPLMN/access technology list, while roaming in a visited network. The WTRU 209 may construct the Requested NSSAI based on the Network Slice Selection Policy (NSSP) and its need to connect to an essential service or application, through a particular Network Slice.

At 210, the visited network accepts the Registration request, via a Registration Accept message, but it may reject the WTRU 209's request for an S-NSSAI that the WTRU absolutely requires. The network may explicitly reject the S-NSSAI, or include it in the Rejected S-NSSAIs, or not provide it in the Allowed NSSAI.

At 212, the WTRU 209 may determine that it does not want to remain in a VPLMN that does not grant, in response to the Requested S-NSSAI, essential S-NSSAIs that the WTRU may absolutely require. As a result, the WTRU 209 may trigger (e.g., based on the fact that that it did not receive SoR information including S-NSSAI in the Registration Accept message) a Deregistration procedure to explicitly request from the HPLMN information regarding VPLMNs where specific network slices are available. To achieve this, the WTRU 209 may provide a new Deregistration Type, such as “S-NSSAI not available”, and additionally, the WTRU may provide which S-NSSAI(s) was/were not available in the current VPLMN (e.g., S-NSSAI from the Requested S-NSSAI that were either rejected or not included in the Allowed NSSAI). If the WTRU 209 provides the “S-NSSAI not available” (or the “lack of S-NSSAI support”) as the Deregistration type, the WTRU may wait for the Deregistration Accept message from the AMF, before reattempting a new Registration (e.g., at 230). The WTRU 209 may deprioritize a VPLMN that has rejected or not granted S-NSSAIs included in the Requested NSSAI.

At 214, a VPLMN AMF 216 may accept the Deregistration request. Additionally, the VPLMN AMF 216 may invoke Nudm_UECM_Deregistration service operation, and the VPLMN AMF may provide the new Deregistration type: “S-NSSAI not available” (or “lack of S-NSSAI support”).

At 218, when the UDM processes the Nudm_UECM_Deregistration service invocation, if the WTRU 209 is not configured to receive the Slice-Aware SoR container, but the WTRU has requested S-NSSAI information, the UDM may decide to set a new flag that implicitly assumes that the WTRU is ready to receive the Slice-Aware SoR information. The UDM may use this flag to deliver the Slice-Aware SoR information in a subsequent Registration attempt, and to provide information about available S-NSSAI in VPLMNs the WTRU 209 may access in the area the WTRU is currently located.

At 220, if the Slice-Aware SoR information is not available in the UDR (Unified Data Repository), the UDM may request SoR information from the SOR-AF (SoR Application Function) 202, and may indicate that the S-NSSAI associated to the VPLMN/access technology is required.

At 222, the SOR-AF 202 may use analytics and information from AMF VPLMN 224 and possible NSSF at the VPLMN to derive S-NSSAI information in TA from relevant VPLMNs. The SOR-AF 202 may include this information in the Slice-Aware SoR container, and provide this information to the UDM.

At 226, if 218 is not executed, the UDM may include the Slice-Aware SoR container in the output of the Nudm_UECM_Deregistration service operation towards the AMF in the VPLMN. For example, the UDM may be required to know the support of the enhanced SoR information by the WTRU 209 to deliver the enhanced Slice-Aware SoR information to the WTRU. Or, it may be that only a WTRU supporting slice-based SoR features can receive the enhanced Slice-Aware SoR information via the UDM, the enhaced Slice-Aware information including preferred VPLMNs for specific S-NSSAIs in the WTRU subscription (a preferred VPLMN list may also be a single VPLMN that is known by the HPLMN to support the S-NSSAI, or a list of VPLMNs in preference order that differs from the order of the basic SoR information that is also provided).

At 228, the AMF 216 may include the Slice-Aware SoR container in the Deregistration Accept message, if it determines that Slice-Aware SoR information may be sent immediately, based on the knowledge that the WTRU 209 is configured to receive the Slice Aware-SoR container.

At 230, if the WTRU 209 received the Slice-Aware SoR container, the WTRU may use this information to execute PLMN selection. The WTRU 209 may decide to Register to attempt access to a specific S-NSSAI, based on the information provided in the Slice-Aware SoR container. If the WTRU 209 did not receive the Slice-Aware container, the WTRU may indicate in the Registration Request message that is capable and ready to receive the Slice-Aware SoR information.

At 232, the VPLMN AMF 224 may support SoR and as such it may trigger an SoR operation through a Nudm_SDM_Get request message, indicating that the S-NSSAI information is also required. The UDM may perform 220 and 222, if not already executed. Note that 220 and 222 may be executed either because of a Nudm_SDM_Get request message or as a result of a Nudm_WTRUCM_Deregistration service operation.

At 234, the UDM may use information from the SOR-AF 202 to provide the list of VPLMN/access technologies and associated S-NSSAIs. If the VPLMN AMF 216 does not support SoR, but the “SoR” Required” flag is set in the UDM, the UDM may decide to send the SoR information by other means, such as through an SMS message.

At 236, the list of VPLMN/access technologies and associated S-NSSAIs may be provided to the WTRU 209 in the Registration Accept message, possibly as part of the SOR container.

At 238, the WTRU 209 may reselect to a higher-priority VPLMN that may support S-NSSAI according to the information received in the SoR container.

Alternatively, when the AMF 216 provides a rejected S-NSSAI to the WTRU 209 in a Registration Accept or a Registration Reject message, the AMF may also send the WTRU an information element (e.g., new information element). In one example, this new information element may be called “Slice-Aware SOR Transparent Container”. This information element may provide the WTRU 209 with a list of preferred PLMN/S-NSSAI/access technology combinations. The network may determine what preferred PLMN/S-NSSAI/access technology combinations to send to the WTRU 209 based on the Allowed NSSAI and rejected S-NSSAI(s) that were sent to the WTRU in the Registration Accept message. The network may determine what preferred PLMN/S-NSSAI/access technology combination(s) to send to the WTRU 209 based on the rejected S-NSSAI(s) that were sent to the WTRU in the Registration Reject message. Upon reception of the “Slice-Aware SOR Transparent Container” from the network, the WTRU 209 may determine to send a de-registration request to the network and may then send a new Registration Request to one of the PLMN/access technology combinations that were indicated in the new information element. The purpose, or benefit, of the deregistration request and new registration request is that the WTRU 209 may gain access to one of the slices that were rejected in the first registration request.

The WTRU 209 may indicate to the network, for example, in a 5GMM Capability Information of a Registration Request, that the WTRU is able to receive and understand the “Slice-Aware SOR Transparent Container.” The benefit of sending such an indication is that the network would be aware of whether the WTRU 209 understands the new information element. Otherwise, the information would be discarded by a non-supporting WTRU without the network being aware that the information was discarded.

The WTRU 209 may explicitly request the “Slice-Aware SOR Transparent Container” from the network. For example, after the WTRU 209 receives a rejected S-NSSAI in a Registration Accept or a Registration Reject message, the WTRU may send a NAS Message to the network requesting that the network send, to the WTRU, PLMN/access technology combination(s) that can be used to access the rejected S-NSSAI. The NAS message may be a UL NAS Transport Message or a Registration Request message.

In systems, methods, and/or devices, there may be approaches for network slice-based Visited Public Land Mobile Network (VPLMN) selection reselection. For example, a Steering of Roaming SoR procedure may be used to convey single Network Slice Selection Assistance Information (S-NSSAI) associated to VPLMN/access technologies while a wireless transmit receive unit (WTRU) 209 is roaming. In an example, RAT/Frequency Selection Priority (RFSP) may be used to determine S-NSSAI that may be broadcast in System Information to aid a WTRU in identifying S-NSSAIs available in neighboring cells. In an example, a WTRU 209 may execute a Deregistration procedure upon receipt of a Registration Accept with Rejected S-NSSAIs the WTRU needs to access, and provide a new Deregistration Type to flag this occurrence. In an example, S-NSSAI-VPLMN/access technology associations in the SOR-AF 202 may be generated using information from the VPLMN Access and Mobility Management function (AMF) 224 and Network Slice Selection Function (NSSF). In an example, a slice-aware steering of roaming information may be provided to a WTRU 209 during a deregistration procedure.

As described herein, a higher layer may refer to one or more layers in a protocol stack, or a specific sublayer within the protocol stack. The protocol stack may comprise of one or more layers in a WTRU 209 or a network node (e.g., eNB, gNB, other functional entity), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

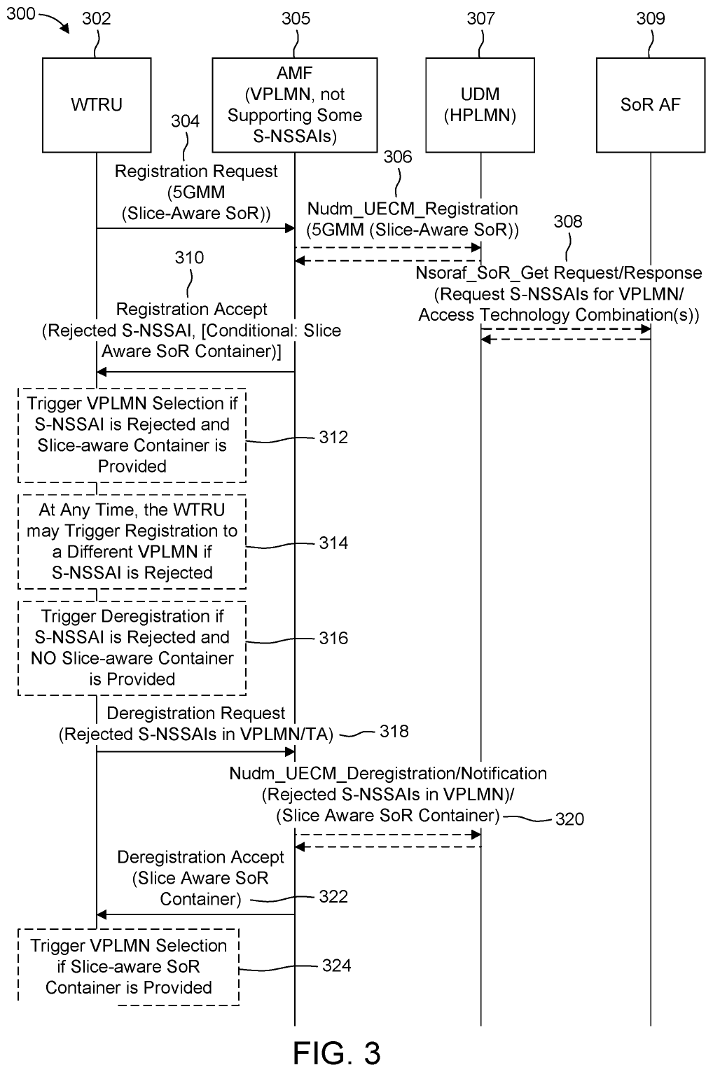

FIG. 3 is a diagram of an example procedure 300 by which a WTRU 302 declares its capability (i.e., informs a network of its capability) to receive a Slice-Aware SoR Container that the WTRU can use to select a VPLMN that supports a particular S-NISSAI, and an associated network slice, according to an embodiment.

At some time before the time at which the registration request of item 304 occurs, the WTRU 302 registered with a network, such as a 5GMM VPLMN having an Access Mobility Management Function (AMF) 305, for the first time, and the network may have sent, to the WTRU, a configured NISSAI, which the WTRU may have stored and still may have available.

At 304, the WTRU 302 issues a registration request to a network, such as a 5GMM VPLMN having an Access and Mobility Management Function (AMF) 305, and the registration request includes information indicating that the WTRU is capable of receiving a Slice Aware SoR Container. The registration request also includes information indicating which, if any, S-NSSAIs, are essential to, or otherwise used by, the WTRU 302. If, per above, the WTRU 302 still stores, in memory, the configured NISSAI that the VPLMN AMF 305 previously sent to the WTRU, then the WTRU may, as part of the registration request, request registration for one or more of the S-NSSAIs present in the previously received configured NISSAI.

At 306, the VPLMN AMF 305 passes the registration request, and the information indicating that the WTRU 302 is capable of receiving a Slice-Aware SoR container, to a User Data Management (UDM) 307 of a HPLMN as a Nudm-UECM Registration. The VPLM AMF 305 may also provide, as assistance information, to the UDM 307 of the HPLMN the S-NSSAI that the VPLMN AMF 305 allowed and the S-NSSAI that the VPLMN AMF rejected. For example, if the rejected NSSAI indicates that a S-NSSAI is rejected with cause such as “S-NSSAI not available in the current PLMN,” then the UDM 306 may steer the WTRU 302 to another VPLMN (see 312, 314, and 316 below).

And at 308, the HPLMN UDM 307 passes the registration request to a Steering of Roaming Application Function (SoR AF) 309 as an Nsoraf-SoR_Get Request message, which can include a request for S-NSSAIs for VPLMN/access technology combinations available on the VPLMN AMF 305 and available on other VPLMNs (e.g., other VPLMNs that are accessible to the WTRU 302). In response to the request, the SoR AF 309 generates a Preferred VPLMN List depending on the NSSAI allowed and the NSSAI rejected by the VPLMN AMF 305 and sends the Preferred VPLMN List to the HPLMN UDM 307 as part of an Nsoraf-SoR_Get_Response message (the HPLMN UDM may forward the Preferred VPLMN List to the WTRU 302 via the VPLMN AMF 305). For example, the Preferred VPLMN List includes the identifiers and the S-NSSAIs supported by the VPLMNs in the list.

At 310, the VPLMN accepts the registration request from the WTRU 302 via the VPLMN AMF 305, and, therefore, the WTRU is registered on the VPLMN.

Still at 310, the VPLMN AMF 305 informs the WTRU 302 whether any of the S-NSSAIs for which the WTRU 302 requested registration (e.g., S-NSSAIs that are essential to, or otherwise requested or usable by, the WTRU 302) are rejected as unsupported by the VPLMN AMF, and sends to the WTRU 302 a Slice Aware SoR Container that includes S-NSSAIs that are supported by the VPLMN AMF and that are supported by one or more other VPLMNs that are nearby the VPLMN AMF with which the WTRU 302 is registered. As an alternative for expressly identifying rejected S-NSSAIs, the VPLMN AMF 305 can omit the rejected S-NSSAIs from the Slice Aware SoR Container and the WTRU 302 can determine that the VPLMN AMF has rejected any S-NSSAIs that are omitted from the Slice Aware SoR Container as being unsupported by the VPLMN AMF.

If, at 310, the VPLMN AMF 305 informs the WTRU 302 that at least one of the S-NSSAIs essential to, or otherwise requested or usable by, the WTRU is unsupported by the VPLMN AMF then the WTRU can take one or more of the following actions at 312, 314, and 316.

At 312, if the WTRU 302 receives a Slice-Aware SoR Container from the VPLMN AMF 305, then the WTRU can select another VPLMN to join (i.e., with which to register) based on a list of VPLMNs in the Slice-Aware SoR Container that support at least one of the one or more S-NSSAIs essential to, or otherwise requested or useable by, the WTRU.

Alternatively, at 314, regardless of whether the WTRU 302 received a Slice-Aware SoR Container from the VPLMN AMF 305, the WTRU effectively can repeat the above procedure with another VPLMN. That is, the WTRU can request registration on another VPLMN and request an indication of whether the other VPLMN supports at least one of the one or more S-NSSAIs essential to, or otherwise requested or usable by, the WTRU. Or, the WTRU 302 can select another VPLMN for which to request registration from the Preferred VPLMN List described above in conjunction with item 308.

In another alternative, at 316, if the VPLMN AMF 305 rejected the one or more S-NSSAIs essential to, or otherwise requested or usable by, the WTRU 302, and did not provide a Slice-Aware SoR Container to the WTRU, then the WTRU can trigger a deregistration from the VPLMN AMF 305, and the deregistration request (318) can include a request for information as to which other VPLMNs, if any, support one or more of the S-NSSAIs essential to, or otherwise requested or usable by, the WTRU. At 320, the HPLMN UDM 302 receives the deregistration request from the VPLMN AMF 305 and can provide this information (as to which other VPLMNs, if any, support one or more of the S-NSSAIs essential to, or otherwise requested or usable by, the WTRU) back to the VPLMN AMF, which, at 322, can provide this information to the WTRU 302 as part of a Slice Aware SoR Container.

And, at 324, in response to information from the VPLMN AMF 305 as to which, if any, other VPLMNs support one or more of the S-NSSAIs essential to, or otherwise requested or usable by, the WTRU 302 (this information can be part of a received Slice Aware SoR Container), the WTRU selects another VPLMN with which to register, where the selected VPLMN supports at least one of the one or more S-NSSAIs essential to, or otherwise requested or usable by, the WTRU. Then, the WTRU 302 registers with the selected VPLMN as described above in conjunction with FIG. 3.

In an embodiment, in response to receiving the registration accept message from the VPLMN AMF 305 at 310, the WTRU 302 sends, transparently to the HPLMN UDM 307 via the VPLMN AMF 305, a registration complete message that includes secured assistance information such as the rejected S-NSSAI and allowed S-NSSAI of the NSSAI as indicated in the registration accept message. The WTRU 302 may send the secured assistance information only when the WTRU receives, from the VPLMN AMF 305, rejections of one or more S-NSSAI, or may send the secured assistance information in the UL NAS TRANSPORT message instead of in a registration complete message; that is, the WTRU 302 may forego sending the registration complete message if the WTRU sends the secured assistance information as part of the UL NAS TRANSPORT.

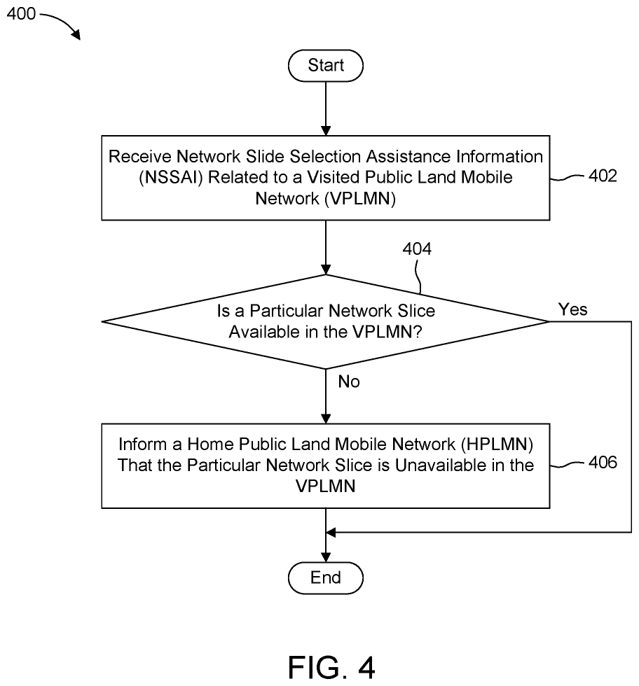

FIG. 4 is a flow diagram 400 of a procedure that a WTRU, such as the WTRU 102 of FIG. 1B, the WTRU 209 of FIGS. 2A-2B, or the WTRU 302 of FIG. 3, can perform, according to an embodiment.

At 402, the WTRU receives Network Slide Selection Assistance Information (NSSAI) related to a Visited Public Land Mobile Network (VPLMN). For example, the NSSAI can be included in a Slice Aware SoR Container that the VPLMN sends to the WTRU, and the NSSAI can indicate which, if any, S-NSSAI and corresponding network slice are supported by (are available in) the VPLMN.

Next, at 404, the WTRU determines whether a particular network slice is available in the VPLMN. For example, the WTRU determines whether the VPLMN supports the S-NSSAI corresponding to the particular network slice.

If, at 404, the WTRU determines that the particular network slice is available in the VPLMN, then the procedure ends.

But if, at 404, the WTRU determines that the particular network slice (and corresponding S-NSSAI) is unavailable in the VPLMN, then the WTRU proceeds to 406.

At 406, the WTRU informs a Home Public Land Mobile Nework (HPLMN) that the particular network slice (and corresponding S-NSSAI) is unavailable in the VPLMN. For example, the HPLMN can be the HPLMN to which the WTRU, or the owner of the WTRU, is subscribed.

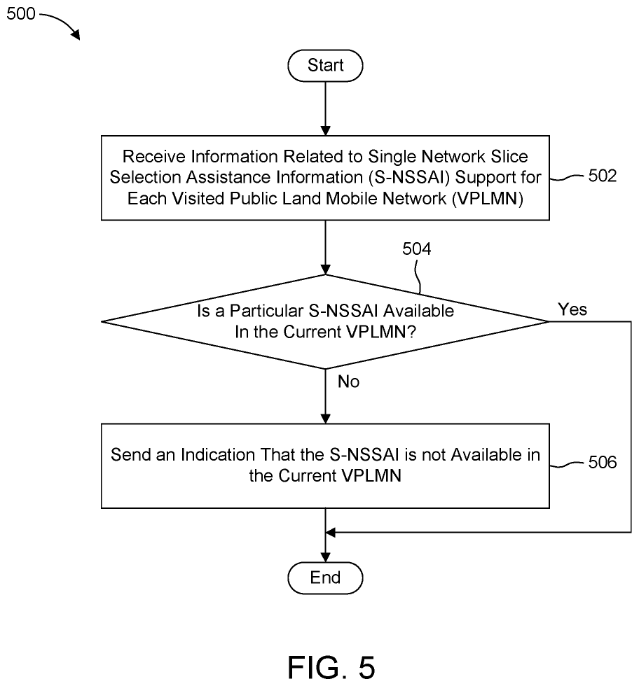

FIG. 5 is a flow diagram 500 of a procedure that a WTRU, such as the WTRU 102 of FIG. 1B, the WTRU 209 of FIGS. 2A-2B, or the WTRU 302 of FIG. 3, can perform, according to another embodiment.

At 502, the WTRU receives information related to Single Network Slide Selection Assistance Information (S-NSSAI) support for each Visited Public Land Mobile Network (VPLMN). For example, the received information can be for each VPLMN in which the WTRU is located or is otherwise able to join from the current location of the WTRU. For example, the S-NSSAIs can be included in one or more Slice Aware SoR Containers that one or more VPLMNs send to the WTRU.

Next, at 504, the WTRU determines whether a particular S-NSSAI, and, therefore, whether a particular network slice, is available in the current VPLMN, that is, the VPLMN with which the WTRU is currently registered.

If, at 504, the WTRU determines that the particular S-NSSAI and corresponding particular network slice are available in the current VPLMN, then the procedure ends.

But if, at 504, the WTRU determines that the particular S-NSSAI and corresponding particular network slice are unavailable in the current VPLMN, then the WTRU proceeds to 506.

At 506, the WTRU sends an indication that the S-NSSAI that corresponds to the particular network slice (and, therefore, the particularly network slice) is unavailable in the current VPLMN. For example, the indication may be, or may be part of, a deregistration request message or a registration request message.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-24. (canceled)

25. A method implemented in a wireless transmit/receive unit (WTRU), the method comprising:
receiving a first message indicating that a requested single network slice selection assistance information (S-NSSAI) is not available on a current visited public land mobile network (VPLMN);
sending a second message indicating that the requested S-NSSAI is not available on the current VPLMN and requesting information regarding accessible VPLMNS on which the requested S-NSSAI is available; and
receiving configuration information indicating information regarding S-NSSAI support for at least one VPLMN.

26. The method of claim 25, further comprising moving out of the current VPLMN responsive to the configuration information.

27. The method of claim 25, wherein the second message comprises a request message, a deregistration message, or a registration request message.

28. The method of claim 25, wherein the second message comprises either a deregistration message or a registration request message, wherein whether the second message comprises a deregistration or a registration message is based on the first message.

29. The method of claim 25, wherein the second message comprises either a deregistration message or a registration request message, wherein whether the second message comprises a deregistration message or a registration message is based on whether the first message indicates slice-aware steering of roaming (SoR) information.

30. The method of claim 25, wherein the second message further indicates a request for roaming information.

31. The method of claim 30, wherein the roaming information includes slice-aware steering of roaming (SoR) information.

32. The method of claim 31, further comprising selecting a VPLMN based on the slice-aware SoR information.

33. The method of claim 31, further comprising selecting an access technology based on the slice-aware SoR information.

34. The method of claim 25, further comprising selecting a VPLMN based on a priority of the VPLMN.

35. A wireless transmit/receive unit (WTRU) comprising:
receiver circuitry configured to receive a first message indicating that a requested single network slice selection assistance information (S-NSSAI) is not available on a current visited public land mobile network (VPLMN);
transmitter circuitry configured to send a second message indicating that the requested S-NSSAI is not available on the current VPLMN and requesting information regarding accessible VPLMNS on which the requested S-NSSAI is available; and
the receiver circuitry further configured to receive configuration information indicating information regarding S-NSSAI support for at least one VPLMN.

36. The WTRU of claim 35, further comprising circuitry configured to move out of the current VPLMN responsive to the configuration information.

37. The WTRU of claim 35, wherein the second message comprises a request message, a deregistration message, or a registration request message.

38. The WTRU of claim 35, wherein the second message comprises either a deregistration message or a registration request message, wherein whether the second message comprises a deregistration message or a registration message is based on the first message.

39. The WTRU of claim 35, wherein the second message comprises either a deregistration message or a registration request message, wherein whether the second message comprises a deregistration message or a registration message is based on whether the first message indicates slice-aware steering of roaming (SoR) information.

40. The WTRU of claim 35, wherein the second message further indicates a request for roaming information.

41. The WTRU of claim 40, wherein the roaming information includes slice-aware steering of roaming (SoR) information.

42. The WTRU of claim 41, further comprising circuitry configured to select a VPLMN based on the slice-aware SoR information.

43. The WTRU of claim 41, further comprising circuitry configured to select an access technology based on the slice-aware SoR information.

44. The WTRU of claim 35, further comprising circuitry configured to select a VPLMN based on a priority of the VPLMN.
